(19) United States
(12) Patent Application Publication
(10) Pub. No.: US 2003/0049396 A1
(43) Pub. Date: Mar. 13, 2003

(54) Container with structured fluid repellent and fluid wettable partial regions of the inner surfaces

(76) Inventors: Markus Oles, Hattingen (DE); Peter Hommes, Zell am Main (DE); Peter Ottersbach, Windeck (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/239,635

(22) PCT Filed: Mar. 9, 2001
(86) PCT No.: PCT/EP01/02664

(30) Foreign Application Priority Data
Mar. 31, 2000 (DE) 200 06 010.4

(51) Int. Cl. B32B 1/02

(52) U.S. Cl. 428/35.7

(57) ABSTRACT

The invention relates to containers whose inner surface has liquid-repellent and wettable subregions, where

a) the liquid-repellent subregions have structuring by elevations with an average height of from 50 nm to 10 μm and with an average separation of from 50 nm to 10 μm, and have a surface energy of less than 35 mN/m for the unstructured material, and

b) the wettable subregions have no elevations.

The present invention relates to containers with inner surfaces which have liquid-repellent subregions of moderate to low surface energy, and wettable subregions.

Articles with liquid-repellent, i.e. low-wettability surfaces have a large number of interesting and economically important features. For example, they are easy to clean, and residues or liquids are easily removed from them.

The use of hydrophobic materials, such as perfluorinated polymers, for producing hydrophobic surfaces is known. A further development of these surfaces consists in structuring their surfaces in the μm to nm range. The resultant advancing angles which can be achieved are up to 150-160°. Markedly more pronounced droplet formation is observed, and, unlike on smooth surfaces, droplets can easily roll off from slightly inclined surfaces.

U.S. Pat. No. 5,599,489 discloses a process in which the surface can be rendered particularly water-repellent by bombardment with particles of an appropriate size followed by perfluorination.

H. Saito et al. in Surface Coating International 4, 1997, p. 168 et seq., describe another process, in which particles made from fluoro polymers are applied to metal surfaces, whereupon the resultant surfaces were observed to have greatly reduced wettability by water and considerably reduced tendency toward icing.

U.S. Pat. No. 3,354,022 and WO 96/04123 describe other processes for lowering the wettability of articles by making topological changes to the surfaces. Here, artificial elevations or depressions with a height of about 5 to 1000 μm and with a separation of from about 5 to 500 μm are applied to hydrophobic materials or to materials hydrophobicized after structuring. Surfaces of this type lead to rapid droplet formation, whereupon the droplets as they roll off entrain dirt particles and thus clean the surface. No information is given concerning any aspect ratio for the elevations.

The processes described above permit the preparation of surfaces which are completely and entirely liquid- and/or dirt-repellent. However, this is frequently not desirable, the desire being instead to produce surfaces which have liquid-repellent and wettable regions. Surfaces with an “intelligent” structure of this type are described in WO 94/27719, for example. The process disclosed here can produce hydrophobic surfaces with hydrophilic and functionalized regions, these regions being hydrophilicized by radiation-chemical methods, and then functionalized by solution-chemistry methods. Surfaces of this type have up to 10,000 functionalized regions per cm² and are used in biological analysis, specifically in DNA sequencing. The amounts of liquid adhering to the functionalized regions are very small, from 50 pl to 2 μl, and can therefore only be applied by automated equipment.

Chemical hydrophilicization followed by functionalization is often not adequate for the tocally defined partition of liquids; desirable surfaces would have a very large difference in adhesion behavior or in contact angle between liquid-repellent and wettable regions.

This is in particular the case when solutions are to be concentrated by evaporation after they have been applied and the resultant concentrate or the dissolved substance is to remain located at a defined site.

Surfaces with structured and unstructured subregions are known, and are disclosed in DE 199 14 007 and DE 198 03 787, for example.

A problem known from another technical sector, biological or pharmaceutical industry, is the packaging of biological or pharmaceutical products—mostly in solution—and the complete, undiluted removal of these solutions from the packaging. Typical packaging is ampoules made from plastic with or without a closure.

High-value biological or pharmaceutical products are often packaged in very small amounts. One reason for this is the high activity of these preparations, and another is the very high price of these substances. Volumes below 100 μl are not unusual here. If these products are supplied in aqueous solution, the surfaces of the containers become wetted with this solution and it is impossible or very difficult to remove the product completely with no residue. High costs are often the result.

An object on which the present invention is based was therefore to develop containers which permit the accumulation of liquids at one location of the container and, with this, complete removal of these liquids.

It has been found that liquids rapidly collect in their entirety in the wettable subregions of containers with inner surfaces with subregions composed of structured surfaces via elevations of a certain height and separation, and with a surface energy of less than 35 mN/m for the unstructured material, and of wettable subregions.

The present invention therefore provides containers whose inner surface has liquid-repellent and wettable subregions, where

a) the liquid-repellent subregions have structuring by elevations with an average height of from 50 nm to 10 μm and with an average separation of from 50 nm to 10 μm, and have a surface energy of less than 35 mN/m for the unstructured material, and

b) the wettable subregions have no elevations.

The wettable subregions of the containers without elevations are flat surfaces without the elevations of the liquid-repellent, structured subregions. They may certainly have small structures, but may not have the dimensions defined for the elevations in the claims. If the subregions without elevations have small structures, these reach not more than 10% of the height of the elevations of the structured surface. The subregions without elevations, or “flat subregions”, may, however, lie upon coarser primary structures, as will be shown below.

To produce the containers of the invention, the surfaces of the containers for the liquid-repellent subregions with a surface energy of less than 35 mN/m may be provided with elevations by mechanical or lithographic means, and then subregions of the resultant structured surface may be coated so as to be wettable.

As stated above, the elevations may have an average height of from 50 nm to 10 μm and an average separation of from 50 nm to 10 μm from one another. However, other heights and separations are also possible. Independently of one another, the average height and the average separation of the elevations may each be from 50 nm to 10 μm or from 50 nm to 4 μm. Furthermore, the elevations may simultaneously have an average height of from 50 nm to 4 μm and an average separation of from 50 nm to 4 μm.

The structured surfaces of the containers—other than the wettable subregions—have particularly high contact angles. This substantially inhibits the wetting of the surface and leads to rapid droplet formation. The droplets on the elevations can roll off when the surface is appropriately inclined, and can adhere to the wettable subregions. The residue-free retreat of the droplet front during concentration of a droplet on the liquid-repellent surface by evaporation is comparable with the behavior of a droplet not present on, but rolling off, the liquid-repellent surface. Here, the residues remain on the wettable subregions.

Surfaces for the present invention are hydrophobic on the liquid-repellent regions if the unstructured material has surface energy of less than 35 mN/m, preferably from 10 to 20 mN/m, and are also oleophobic if the unstructured material has surface energy of less than 20 mN/m. This property extends the fields of application of the containers to sectors where they come into contact with oil-containing liquids or with other organic liquids, or solutions with low surface tension (e.g. lipophilic compounds).

Bacteria and other microorganisms need water in order to adhere to a surface or to multiply on a surface, but on the hydrophobic surfaces of the present invention no water is available. The structured surfaces of the containers of the invention inhibit the growth of bacteria and of other microorganisms at the liquid-repellent regions and are to this extent also bacteriophobic and/or antimicrobial. However, if the parameters, such as humidity and temperature, are appropriate the containers structured according to the invention permit locally defined growth of bacteria and of other microorganisms at the wettable subregions. Since the underlying effect is not based on antimicrobial active ingredients, but on a physical effect, there is no possibility that the growth of bacteria and of other microorganisms on the wettable subregions will be impaired by the liquid-repellent regions, e.g. by exudation and/or diffusion of active ingredients.

The wettability of the surfaces may be characterized by measuring surface energy. One way of accessing this variable is by measuring the contact angles of various liquids on the smooth material (D. K. Owens, R. C. Wendt, J. Appl. Polym. Sci. 13, 1741 (1969)) and is given in mN/m (millinewtons per meter). Smooth polytetrafluoroethylene surfaces have a surface energy of 19.1 mN/m, as determined by Owens et al., the contact angle (advancing angle) with water being 120°. Hydrophobic materials generally have contact angles (advancing angles) of more than 90° with water. For example, polypropylene, with a surface energy of from 29 to 30 mN/m (depending on the molecular structure) has an advancing angle of about 105° with respect to water.

The contact angle and, respectively, surface energy are advantageously measured on smooth surfaces, in order to ensure better comparability. The chemical composition of the uppermost molecular layers of the surface play a part in determining the “hydrophobic”, “liquid-repellent”, or “wettable” properties of the material. Coating processes may therefore also be used to achieve higher contact angles or lower surface energy for a material.

The contact angles at the liquid-repellent regions of containers of the invention are higher than for the corresponding smooth materials and, respectively, the wettable regions. The contact angle observed macroscopically is therefore a surface property which reflects the properties of the material plus the surface structure.

The contact angles at the wettable regions of the containers of the invention are lower than for the liquid-repellent regions. This can be achieved by using various surface structures or differing surface chemistry, or a combination of both, on the respective regions, in that:

the wettable subregions have the same surface chemistry as the rest of the surface, but different elevations. There is no difference in the surface chemistry across the entire surface. Ideally, the wettable subregions have no elevations;

the wettable and liquid-repellent regions have different elevations and surface chemistry. This means that, determined in each case on the unstructured material, the surface energy of the wettable subregions is higher than that of the rest of the surface.

A very wide variety of processes may be used to produce the surfaces and, respectively, the subregions. Two versions will be presented below.

Version A)

The unstructured surfaces of a prefabricated container initially have a surface energy of less than 35 mN/m, and are provided with elevations of height and separation within the ranges mentioned, by a mechanical or lithographic means. Subregions of the container may then be coated so as to be wettable. An example of a method for this purpose is that the structured surface is covered with a mask which continues to give access to the regions to be treated. The unprotected regions may then be activated by physical methods. Use may be made here of plasma treatment, high-frequency treatment or microwave treatment, or of electromagnetic radiation, e.g. laser or UV radiation in the range from 180 to 400 nm, or of electron beams or flame treatment. These methods generate free-radical sites on the surface of the material by a thermal or photochemical method, and in air or an oxygen atmosphere these sites rapidly form hydroxy groups, hydroperoxide groups, or other functional groups which are polar and therefore provide wettability.

This physical method may also be followed by chemical modification in the second step, further improving wettability properties. In this, the functional groups are further reacted with stable end groups, such as monomers capable of polymerization by a free-radical route. One example of this chemical modification is free-radical graft polymerization of vinyl monomers, e.g. acrylamide or acrylic acid, which takes place sufficiently rapidly above 70° C. via the thermally initiated free-radical decomposition of the hydroperoxide groups.

A method which has proven successful in practice is the provision of a wettable coating to the subregions via electromagnetic radiation.

Version B)

In another version for producing containers of the invention, an unstructured surface of a container may be provided with elevations by a mechanical or lithographic method. This surface is then coated with a material with surface energy of less than 35 mN/m, and the coating is removed again from subregions of the resultant structured surface by mechanical or lithographic means. It is advantageous to use an unstructured material with surface energy above 35 mN/m, preferably from 35 to 75 mN/m. After removal of the coating, the wettable subregions have very substantially the properties of the original material.

Since it is in particular the chemical properties of the uppermost monolayers of the material which are decisive for the contact angle, it can, where appropriate, be sufficient to modify the surface using compounds which contain hydrophobic groups. Processes of this type comprise the covalent linking of monomers or oligomers to the surface via a chemical reaction, e.g. treatments with fluoroalkylsilanes, such as Dynasylan F 8262 (Sivento Chemie Rheinfelden GmbH, Rheinfelden), or with ormocers. Ormocers, e.g. Definite Matrix (Degussa-Hüls AG) may also be used in the form of a coating, in order to apply the elevations with the required dimensions to a surface. These coatings are applied to a smooth surface and polymerized by radiation-chemical methods, whereupon appropriate elevations form.

Other processes which should be mentioned are those in which free-radical sites are first generated on the surface and are consumed by reaction with monomers capable of polymerization by a free-radical route, in the presence or absence of oxygen. The surfaces may be activated by means of plasma, UV radiation, or a-radiation, or else by specific photoinitiators. After activation of the surface, i.e. generation of free radicals, the monomers may be attached by polymerization. A process of this type generates a surface with particularly good mechanical resistance.

A method which has proven particularly successful is the coating of subregions of the inner sides of a container by plasma polymerization of fluoroalkenes or vinyl compounds. The vinyl compounds may also be perfluorinated or partially fluorinated compounds.

The liquid-repellent coating of a structured or unstructured surface with a material with surface energy below 35 mN/m may be achieved via fluoroalkylsilanes of, for example, by plasma polymerization of fluoroalkenes or of perfluorinated or partially fluorinated vinyl compounds. It is also possible to use a HF hollow-cathode plasma source with argon as carrier gas and C₄F₈ as monomer, at a pressure of about 0.2 mbar. Surface energies even below 20 mN/m are achieved by this method.

In addition, both the structured and the unstructured subregions of a container may be coated with a thin layer of a hydrophobic polymer. This may be applied in the form of a coating, or by polymerizing appropriate monomers on the surface of the article. Polymeric coatings which may be used are solutions or dispersions of polymers, e.g. polyvinylidene fluoride (PVDF) or reactive coatings.

For a liquid-repellent coating resulting from polymerization on the structured surfaces of a container, particular monomers which may be used are fluoroalkylsilanes, such as Dynasylan F 8262 (Sivento Chemie Rheinfelden GmbH, Rheinfelden).

Hydrophobic or liquid-repellent coatings, or elevations on subregions of these structured subregions, may in turn be removed by mechanical, thermal, photoablative, or lithographic means. An example of a mechanical means for this purpose is micro-machining, e.g. by drilling or milling. The tooling may, for example, be fairly precisely positioned by CNC equipment. An example of a lithographic or thermal means is irradiation using a laser in a wavelength range within which the coating material absorbs energy. For example, for polymethyl methacrylate (PMMA) this applies at 193 nm, and a particularly suitable method for ablating the coating is therefore an ArF* eximer laser.

Particularly low surface energy is needed in particular when oleophobic behavior is required in addition to hydrophobic behavior. This applies in particular when oily liquids are used. Specifically, these wet non-oleophobic surfaces, with a lasting adverse effect on the properties mentioned. For these applications, the surface energy of the unstructured material should be below 20 mN/m, preferably from 5 to 20 mN/m.

As mentioned above, the surface energy of smooth polytetrafluoroethylene surfaces is 19.1 mN/m. Using hexadecane as liquid with low surface tension, the contact angle (advancing angle) is 49°. Surfaces which have been modified with fluoroalkylsilanes, e.g. Dynasylan F 8262 (Sivento Chemie, Rheinfelden) have surface energies below 10 mN/m. Advancing angles measured using hexadecane here are up to 80°. The contact angle of polypropylene with respect to hexadecane is estimated at below 10° (difficult to determine experimentally) at surface energy of from 29 to 30 mN/m.

The surface properties of the liquid-repellent regions of the containers of the invention are dependent on the height, the shape, and the separation of the elevations.

The ratio of height to width of the elevations, the aspect ratio, is also significant. The elevations preferably have an aspect ratio of from 0.5 to 20, with preference from 1 to 10, and particularly preferably from 1 to 3.0.

In order to achieve the low contact angles of the liquid-repellent regions, the chemical properties of the material are significant alongside the structural properties. It is in particular the chemical composition of the uppermost monolayer of the material which is decisive here. The liquid-repellent regions of the containers of the invention are therefore advantageously produced from materials which have hydrophobic behavior even prior to the structuring of their surface. These materials comprise in particular poly(tetrafluoroethylene), poly(trifluoroethylene), poly(vinylidene fluoride), poly(chlorotrifluoroethylene), poly(hexafluoropropylene), poly(perfluoropropylene oxide), poly(2,2,3,3-tetrafluorooxetane), poly(2,2-bis(trifluoromethyl)-4,5-difluoro-1,3-dioxole), poly(fluoroalkyl acrylate), poly(fluoroalkyl methacrylate), poly(vinyl perfluoroalkyl ether), or another polymer made from perfluoroalkoxy compounds, poly(ethylene), poly(propylene), poly(isobutene), poly(isoprene), poly(4-methyl-1-pentene), poly(vinyl alkanoates), or poly(vinyl methyl ether), in the form of homo- or copolymer. These materials may also be used as a constituent in the mixture of a polymer blend. The container is advantageously composed entirely of these materials.

There are also possible mixtures of polymers with additives which become oriented during the molding process in such a way that hydrophobic groups predominate at the surface. Fluorinated waxes, e.g. the Hostaflons from Hoechst AG, are an additive which may be used.

The structuring of a subregion may also be carried out after the hydrophobic coating of a material. The chemical modification of the surface by a liquid-repellent coating may also be carried out after shaping.

The shaping or structuring of a subregion may be achieved by embossing/rolling, or simultaneously during macroscopic molding of the container, e.g. casting, injection molding, or other shaping processes. This requires appropriate negative molds of the desired structure. Containers of the invention with capacity from 0.1 to 1 ml may be produced very simply by injection molding.

An example of an industrial method for producing negative molds is the Liga technique (R. Wechsung in Mikroelektronik, 9, (1995) p. 34 et seq.). Here, one or more masks are produced by electron-beam lithography as required by the dimensions of the desired elevations. These masks serve for irradiation of a photoresist layer, using deep X-ray lithography, giving a positive mold. The final irradiation through the mask can also serve to introduce the flat subregions which are subsequently wettable. The interstices in the photoresist are then filled by electrolytic deposition of a metal. The resultant metal structure is a negative mold for the structure desired.

Laser holography may also be used for irradiation of a photoresist layer. If the photoresist here is irradiated orthogonally with wave-interference patterns, the result is what is known as a motheye structure, giving a positive mold.

If as yet no flat subregions which will subsequently be wettable have been introduced into the resultant metallic negative mold, the negative mold may be subjected to downstream mechanical operations, where micro-machining is used to ablate desired sites on the structure mechanically.

In another embodiment of the present invention, the elevations have been arranged on a somewhat coarser primary structure.

The elevations have the abovementioned dimensions, and may be applied to a primary structure with an average height of from 10 nm to 1 mm and with an average separation of from 10 nm to 1 mm.

The elevations and the primary structure may be simultaneously or successively mechanically impressed, or applied by lithographic methods or by shaping processes, in this case in particular by means of injection molding and appropriate negative molds.

The elevations and the primary structure may have a periodic arrangement. However, stochastic distributions of the dimensions of the primary structure and of the elevations are also permissible, and may be simultaneous or independent of one another. In the case of stochastic structures, the roughness is mostly defined via roughness parameters. The surface parameters which may be given are the arithmetic mean roughness Ra, the average roughness depth Rz, and the maximum roughness depth Rmax. Structured subregions of containers of the invention may have Ra from 0.2 to 40 μm, Rz from 0.1 to 40 μm, and Rmax from 0.1 to 40 μm.

For surfaces with a primary structure, as for surfaces with only a microstructure, the shaping or structuring of the inner surfaces of the container advantageously takes place in one operation. Subsequent hydrophobicization or subsequent chemical modification of a previously produced “double-structured” surface is, of course, also possible.

Containers of the invention are transparent if the dimension of the structuring is less than 400 nm and are then suitable for any of the applications where high transmission or good optical properties are vital. Mention should be made here in particular of the production or coating of containers in optical analysis, for example.

Containers of the invention therefore have excellent suitability for the storage of biological or pharmaceutical products where liquids have to be partitioned over small regions, and the liquid collects on the wettable regions when the container is gently shaken or gently inclined.

Possible applications for the containers: high-quality peptides and other biological substances are usually stored in what are known as “Eppendorf” capsules. These storage containers are usually produced from polyethylene, and have a capacity of from a few hundred μL to a few mL. These containers may be sealed by a closure system and, where appropriate, deep-frozen. Due to the storage conditions, the liquid substance generally becomes randomly distributed on the surfaces. For complete removal of a specimen, however, accumulation of the substance at a single location is desirable. The invention described can provide assistance here. Microstructuring of the abovementioned type on the inner surfaces makes it possible for all of the substance to collect at one location and be available for complete removal.

However, the abovementioned invention may also be used in the environmental protection sector, during the use of toxic substances. There are also possible ampoules and storage containers for medicaments administered parenterally.

The examples below are intended to provide further illustration of the invention without limiting the scope of protection afforded thereto.

### EXAMPLE 1

Medicaments which are administered intravenously or subcutaneously are stored in ampoules or small containers. The ready-to-use solution rarely exceeds 1 mL here. Shaking means that small droplets are always present on the surfaces of these vessels. When the liquid is removed using a needle, these droplets often remain as a residue on the walls, thus reducing by up to 10% the amount of solution available. For medicaments this means relatively high dosage inaccuracy, and also high cost in the case of very valuable solutions.

These losses may be avoided by equipping storage containers internally with a microstructured hydrophobic surface. Two half-shells made from polyethylene are molded with the aid of the Liga technique. The surfaces facing toward the liquid have elevations with an average height of from 1 to 5 μm and with a separation of from 1 to 3 μm. The molding of the two half-shells is such that there are no elevations on the base of the resultant ampoules, i.e. the base is designed as an unstructured subregion. Prior to the welding of the two semifinished products together, the surfaces are hydrophobicized with Dynasylan® F8262. For this, the containers are dipped for 5 minutes in a ready-to-use solution of Dynasylan® F8262. The containers are then placed so that the excess solution can run off. The liquid in the resultant containers always runs off from the sides in the form of droplets and withdraws to the site with the lowest potential energy, i.e. to the unstructured subregion at the base of the ampoule.

### EXAMPLE 2

The surfaces facing toward the liquid in commercially available ampoules or storage containers are wetted with an ormocer solution (e.g. Definite Matrix®). This solution is mixed with a photoinitiator system which initiates crosslinking via irradiation with light of wavelength 308 nm. A suitable initiator system is 2,2′-dimethoxy-2-phenylacetophenone at a concentration of from 0.5 to 1%. An irradiation time of 30 s is sufficient to obtain an adequate crosslinked layer. The ormocer coating is applied in a roller apparatus, so that the base of the ampoules or containers remains uncoated and therefore has no elevations after curing of the coating. The coated subregions of the containers have elevations with an average height of from 1 to 5 μm and with an average separation of from 1 to 3 μm. The superfluous ormocer solution is then rinsed out. In the next step, the surfaces then have to be hydrophobicized. For this, the containers are dipped for 5 minutes in a ready-to-use solution of Dynasylan® F8262. The containers are then placed so that the excess solution can run off. The liquid in the resultant containers always runs off from the sides in the form of droplets and withdraws to the site with the lowest potential energy, i.e. to the unstructured subregion at the base of the container.

### EXAMPLE 3

The ormocer coating is applied as in Example 2, except that the coating is applied within the entire container, i.e. the elevations are present on the entire inner surface. In contrast, the hydrophobicization with Dynasylan® F8262 takes place in a roller apparatus so that the base of the vessel is not hydrophobicized.

The liquid in the resultant containers always runs off from the sides in the form of droplets and withdraws to the site with the lowest potential energy, i.e. to the unstructured subregion at the base of the ampoule, or at the base of the container.

What is claimed is:

1. A container whose inner surface has liquid-repellent and wettable subregions,
wherein
a) the liquid-repellent subregions have structuring by elevations with an average height of from 50 nm to 10 μm and with an average separation of from 50 nm to 10 μm, and have a surface energy of less than 35 mN/m for the unstructured material, and
b) the wettable subregions have no elevations.

2. The container as claimed in claim 1,
wherein
determined in each case on the unstructured material, the surface energy of the wettable subregions is higher than that of the remainder of the surface.

3. The container as claimed in claim 1 or 2,
wherein
the elevations have an average height of from 50 nm to 4 μm.

4. The container as claimed in claim 1 or 2,
wherein
the average separation of the elevations is from 50 nm to 4 μm.

5. The container as claimed in claim 1 or 2,
wherein
the elevations have an average height of from 50 nm to 4 μm and an average separation of from 50 nm to 4 μm.

6. The container as claimed in any of claims 1 to 5,
wherein
the elevations have an aspect ratio of from 1 to 10.

7. The container as claimed in any of claims 1 to 6,
wherein
the elevations have been applied to a primary structure with an average height of from 10 μm to 1 mm and with an average separation of from 10 μm to 1 mm.

8. The container as claimed in any of claims 1 to 7,
wherein
the unstructured material comprises poly(tetrafluoroethylene), poly(trifluoroethylene), poly(vinylidene fluoride), poly(chlorotrifluoroethylene), poly(hexafluoropropylene), poly(perfluoropropylene oxide), poly(2,2,3,3-tetrafluorooxetane), poly(2,2-bis(trifluoromethyl)-4,5-difluoro-1,3-dioxole), poly(fluoroalkyl acrylate), poly(fluoroalkyl methacrylate), poly(vinyl perfluoroalkyl ether), or another polymer made from perfluoroalkoxy compounds, poly(ethylene), poly(propylene), poly(isobutene), poly(isoprene), poly(4-methyl-1 pentene), poly(vinyl alkanoates), or poly(vinyl methyl ether), in the form of homo- or copolymer.
